(19) United States
(12) Patent Application Publication
(10) Pub. No.: US 2022/0114935 A1
(43) Pub. Date: Apr. 14, 2022

(54) DISPLAY DEVICE

(71) Applicant: AU Optronics Corporation, HSIN-CHU (TW)

(72) Inventors: Che-Chia CHANG, HSIN-CHU (TW); Ming-Hung CHUANG, HSIN-CHU (TW)

(21) Appl. No.: 17/381,439

(22) Filed: Jul. 21, 2021

(30) Foreign Application Priority Data
Oct. 14, 2020 (TW) 109135556

(51) Int. Cl. G09G 3/20

(52) U.S. Cl. CPC G09G 3/20; G09G 2310/0254; G09G 2310/0297

(57) ABSTRACT

A display device includes a plurality of first pixels, a plurality of second pixels, a plurality of first multiplexers, a plurality of second multiplexers, a plurality of first traces, a plurality of second traces, and an integrated circuit. First multiplexers are used to control first pixels. Second multiplexers are used to control second pixels. First traces are coupled to each of first multiplexers. Second traces are coupled to each of second multiplexers. Integrated circuit includes at least two first polarity pins s and at least two second polarity pins. At least two first polarity pins s are adjacent. At least two second polarity pins are adjacent. At least two first polarity pins and at least two second polarity pins are arranged alternately. At least two first polarity pins s are coupled to first traces. At least two second polarity pins are coupled to second traces.

### CROSS-REFERENCE TO RELATED APPLICATION

This application claims priority to Taiwan Application Serial Number 109135556, filed on Oct. 14, 2020, which is herein incorporated by reference in its entirety.

### BACKGROUND

### Field of Invention

The present disclosure relates to an electronic device. More particularly, the present disclosure relates to a display device.

### Description of Related Art

In recent years, due to needs of narrow border of a panel, many display devices are gradually using in a Chip On Film (COF) technology such that a height of a fan-out area in narrow border of a panel is compressed. Furthermore, a power consumption of a fan-out area accounts for a large proportion of a power consumption of a total panel.

For the foregoing reason, there is a need to provide structures of a display device or a display panel to solve the problems of the prior art.

### SUMMARY

One aspect of the present disclosure provides a display device. The display device includes a plurality of first pixels, a plurality of second pixels, a plurality of first multiplexers, a plurality of second multiplexers, a plurality of first traces, a plurality of second traces, and an integrated circuit. The first pixels and the second pixels are arranged in an interlaced manner. The first multiplexers are configured to control the first pixels, and include at least three first switches. One of the at least three first switches is configured to control the second pixels. The second multiplexers are configured to control the second pixels, and include at least three second switches. One of the at least three second switches is configured to control the first pixels. Each of the first multiplexers and each of the second multiplexers are arranged in an interlaced manner. The first traces are coupled to each of the first multiplexers. The second traces are coupled to each of the second multiplexers. The integrated circuit includes at least two first polarity pins and at least two second polarity pins. The at least two first polarity pins are adjacent. The at least two second polarity pins are adjacent. The at least two first polarity pins and the at least two second polarity pins are arranged in an interlaced manner. The at least two first polarity pins are coupled to the first traces. The at least two second polarity pins are coupled to the second traces. A polarity of each of the first polarity pins is opposite to a polarity of each of the second polarity pins.

### BRIEF DESCRIPTION OF THE DRAWINGS

The present disclosure can be more fully understood by reading the following detailed description of the embodiment, with reference made to the accompanying drawings as follows:

FIG. 1 depicts a part structure diagram of a display device according to some embodiments of the present disclosure;

FIG. 2 depicts an enlarged view of a part structure diagram of a display device according to some embodiments of the present disclosure;

FIG. 3 depicts a sectional view of a fan-out area of a display device according to some embodiments of the present disclosure;

FIG. 4 depicts an enlarged view of a part structure diagram of a display device according to some embodiments of the present disclosure; and

FIG. 5 depicts an enlarged view of a part structure diagram of a display device according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The terminology used herein is for the purpose of describing particular example embodiments only and is not intended to be limiting of the present disclosure. As used herein, the singular forms “a,” “an” and “the” are intended to include the plural forms as well, unless the context clearly indicates otherwise.

Furthermore, it should be understood that the terms, “comprising”, “including”, “having”, “containing”, “involving” and the like, used herein are open-ended, that is, including but not limited to.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

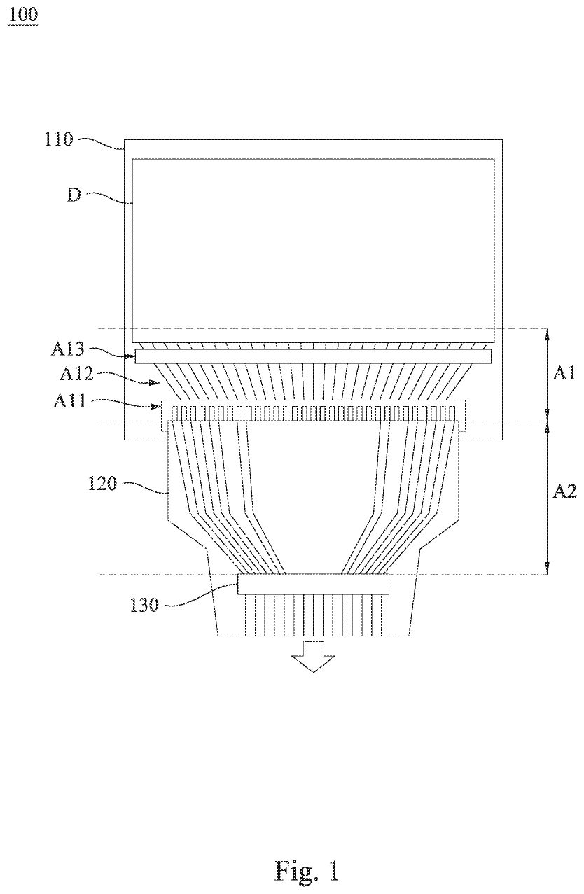

FIG. 1 depicts a part structure diagram of a display device 100 according to some embodiments of the present disclosure. In some embodiments, as shown in FIG. 1, the display device 100 includes a panel 110, a multiplexer area A13, a flexible printed circuit 120, and an integrated circuit 130. Multiplexers in the multiplexer area A13 are located on the panel 110. The integrated circuit 130 is located on the on the 120.

In addition, as shown in FIG. 1, the panel 110 includes a display area D and a peripheral area A1. The display area D is located at a first side of the panel 110. The peripheral area A1 is located at a second side of the panel 110. The first side is opposite to the second side. Although the first side and second side are shown as an upper side and a lower side in the figure. In practice, the first side and second side are not limited to the upper side and the lower side.

In some embodiments, the display area D includes a plurality of first pixels (not shown in the figure) and a plurality of second pixels (not shown in the figure), In order to facilitate the understanding of structures of a display device, detail structures will be explained in the following paragraphs.

In some embodiments, the multiplexer area A13 is located in the peripheral area A1. In some embodiments, the flexible printed circuit 120 includes a package fan-out area A2.

In some embodiments, the integrated circuit 130 is attached to the flexible printed circuit 120 through Chip on film (COF) technology, and is partly overlapped to form a bonding area A11 with the flexible printed circuit 120. In some embodiments, the bonding area A11 is located in the peripheral area A1.

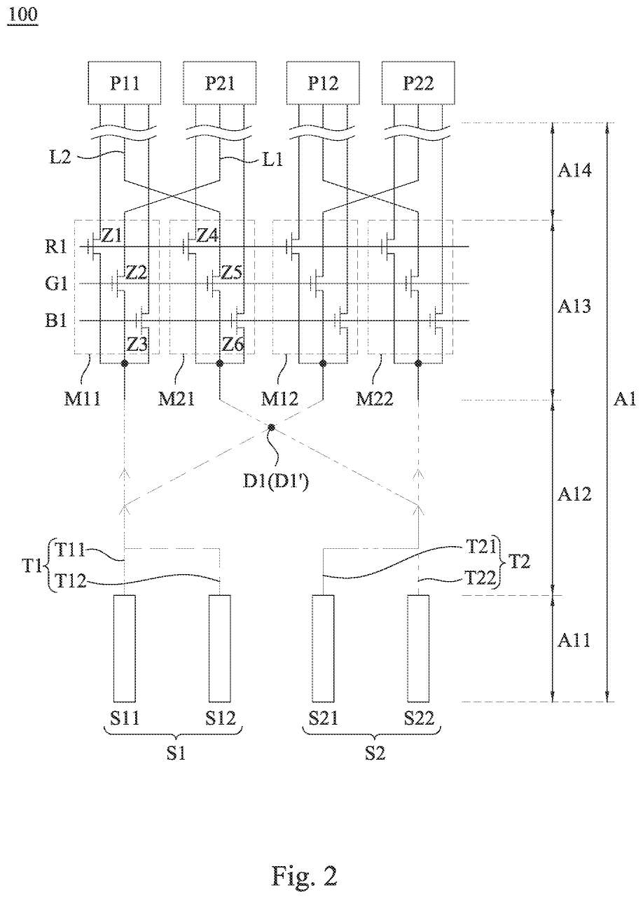

FIG. 2 depicts an enlarged view of a part structure diagram of a display device 100 according to some embodiments of the present disclosure. In some embodiments, FIG. 2 is an enlarged view corresponding to the peripheral area A1 shown in FIG. 1. In some embodiments, the peripheral area A1 includes the bonding area A11, a fan-out area A12, the multiplexer area A13, and a data line area A14.

In some embodiments, please refer to FIG. 2, the display device 100 includes a plurality of first pixels (ex. a first pixel P11 and a first pixel P12), a plurality of second pixels (ex. a second pixel P21 and a second pixel P22), a plurality of first multiplexers (ex. a first multiplexer M11 and a first multiplexer M12), a plurality of second multiplexers (ex. a second multiplexer M21 and a second multiplexer M22), a plurality of first traces T1, and a plurality of second traces T2. The first pixels and the second pixels are arranged in an interlaced manner. Each of pixels includes three sub pixels. The three sub pixels are configured to display red, green, blue, and other colors respectively. Each of sub-pixels is connected to the corresponding data line respectively. It should be noted that the first pixels and the second pixels shown in the figure represent pixels controlled by the adjacent multiplexers in different rows.

In some embodiments, the data line area A14 is a narrow area which the data lines leave from multiplexer area A13 and enter before the display area D shown in FIG. 1. The data lines are configured to the pixels and the multiplexers. In other words, each of the multiplexers is configured to connect to the pins so as to receive signals from the integrated circuit 130, and is configured to connect to the corresponding data lines and the corresponding sub pixels.

In addition, please refer to FIG. 2, the multiplexer area A13 includes a plurality of first multiplexers (ex. a first multiplexer M11 and a first multiplexer M12) and a plurality of second multiplexers (ex. a second multiplexer M21 and second multiplexer M22). The first multiplexers are configured to control the first pixels (ex. the first pixel P11 and the first pixel P12). Each of the first multiplexers includes at least three first switches (ex. a first switch Z1, a first switch Z2, and a first switch Z3). One of the at least three first switches (ex. the first switch Z2) is configured to control the second pixels (ex. the second pixel P21). The second multiplexers are configured to control the second pixels. Each of the second multiplexers includes at least three second switches (ex. a second switch Z4, a second switch Z5, and a second switch Z6). One of the at least three second switches (ex. the second switch Z5) is configured to control the first pixels (ex. the first pixel P11). Each of the first multiplexers and each of the second multiplexers are arranged in an interlaced manner.

Further, the fan-out area A12 includes the first traces T1 and the second traces T2. The first traces T1 are coupled to each of the first multiplexers (ex. the first multiplexer M11 and the first multiplexer M12). The second traces T2 are coupled to each of the second multiplexers (ex. the second multiplexer M21 and the second multiplexer M22).

In addition, the bonding area A11 includes at least two first polarity pins S1 and at least two second polarity pins S2. The at least two first polarity pins S1 are adjacent. The at least two second polarity pins S2 are adjacent. The at least two first polarity pins S1 and the at least two second polarity pins S2 are arranged in an interlaced manner. The at least two first polarity pins S1 are coupled to the first traces T1. The at least two second polarity pins S2 are coupled to the second traces T2. For example, a first polarity pin S11 and First polarity pin S12 are adjacent. A second polarity pin S21 and second polarity pin S22 are adjacent. A polarity of each of the first polarity pins is opposite to a polarity of each of the second polarity pins.

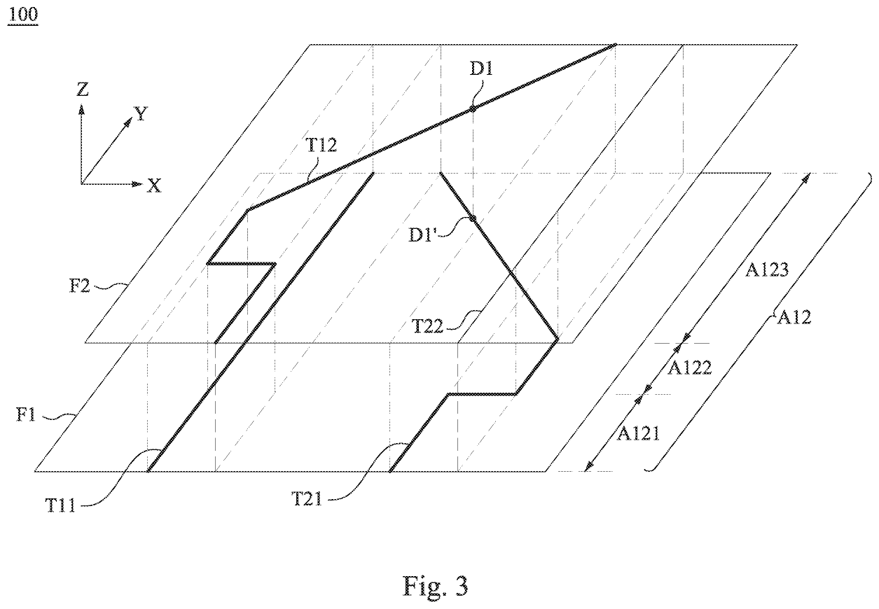

In some embodiments, in order to facilitate the understanding of a sectional view of structures of the fan-out area A12 of the display device 100 of present disclosure, please refer to FIG. 2 and FIG. 3, FIG. 3 depicts a sectional view of a fan-out area A12 of a display device 100 according to some embodiments of the present disclosure. The sectional view of the fan-out area A12 shown in FIG. 3 is corresponding to the fan-out area A12 shown in FIG. 2. The first traces T1 and the second traces T2 in the fan-out area A12 include different structures of a front section A121, a middle section A122, and a rear section A123 from the bottom to top of the figure, but not limited to the embodiments shown in the figure and narrative sequence in these embodiments.

In some embodiments, each of the first traces which are coupled to the at least two first polarity pins is adjacent. Each of the second traces which are coupled to the at least two second polarity pins is adjacent. It should be noted that the structure in this embodiment is a change structure of the front section A121 of the fan-out area A12. For example, please refer to FIG. 2, the first polarity pin S11 is coupled to the first trace T11. The first polarity pin S12 is coupled to the first trace T12. The first trace T11 and the first trace T12 are adjacent. Similarly, the second polarity pin S21 is coupled to the second trace T21. The second polarity pin S22 is coupled to the second trace T22. The second trace T21 and the second trace T22 are adjacent. It should be noted that the first traces T1 and the second traces T2 are adjacent in the front section A121 of the fan-out area A12 which the traces are just out of the bonding area A11.

In some embodiments, please refer to FIG. 2 and FIG. 3, the sectional structures of the fan-out area A12 include a first conductive layer F1 and a second conductive layer F2. The second conductive layer F2 is located on the upper layer of the first conductive layer F1. The second conductive layer F2 and the first conductive layer F1 are electrically insulated from each other. The first trace T11 and the first trace T12 of the first traces which are adjacent are disposed on the first conductive layer F1 and the second conductive layer F2, and are overlapped to each other in a vertical projection direction. The adjacent second trace T21 and the second trace T22 of the second traces are disposed on the first conductive layer F1 and the second conductive layer F2, and are overlapped to each other in a vertical projection direction. It should be noted that the fan-out area A12 is composed of multiple layers of metal. Each of the first traces T1 is disposed on the different layers respectively. Each of the second traces T2 is disposed on the different layers respectively. Further, the structure in this embodiment is a change structure of the middle section A122 of the fan-out area A12. If the fan-out area A12 is located on a XY-plane, the first conductive layer F1 and the second conductive layer F2 extend along a Z-axis. For example, the first trace T11 is disposed on the first conductive layer F1, and the first trace T12 is disposed on the second conductive layer F2. The first trace T11 and the first trace T12 are overlapped to each other a vertical projection direction. Similarly, the second trace T21 and the second trace T22 are disposed on the different conductive layers, and are overlapped to each other a vertical projection direction.

In some embodiments, the first traces and the second traces are not coupled to each other, and form at least one cross point in a vertical projection direction. It should be noted that the structure in this embodiment is a change structure of the rear section A123 of the fan-out area A12. For example, please refer to FIG. 2 and FIG. 3, the first trace T11 and the second trace T21 are located on the first conductive layer F1, the first trace T12 and the second trace T22 are located on the second conductive layer F2. In practice, the first traces and the second traces are not coupled to each other. The first trace T12 and the second trace T2 form at least one cross point D1 which is corresponding to a projection point D1′ in a vertical projection direction. It should be noted that aforementioned structure is a change structure of the rear section A123 of the fan-out area A12 which the first traces T1 and the second traces T2 will leave from the fan-out area A12 and are coupled to the multiplexer area A13. It should be noted that a length and a shape of the traces, a length of the front section A121, the middle section A122, and the rear section A123 of the fan-out area A12, and a distance between the first conductive layer F1 and the second conductive layer F2 are not limited to the embodiments shown in the figure.

In some embodiments, each of the at least three first switches of the first switches includes a first end, a second end, and a control end. The second ends of the at least three first switches are all connected in parallel, and are coupled to one of the at least two first polarity pins through one of the first traces. Each of the at least three second switches of the second switches includes a first end, a second end, and a control end. The second ends of the at least three second switches are all connected in parallel, and are coupled to one of the at least two second polarity pins through one of the second traces. For example, please start from a top of components as a first end, each of three first switches of the first multiplexer M11 (ex. a first switch Z1, a first switch Z2, and a first switch Z3 shown in the figure) includes the first end, the second end, and the control end. The second ends of the three first switches of the first multiplexer M11 are all connected in parallel, and are coupled to the first polarity pin S11 through the first trace T11. The second ends of the three first switches of the first multiplexer M12 are all connected in parallel, and are coupled to the first polarity pinS12 through the first trace T12.

Similarly, each of three second switches of the second multiplexer M12 (ex. a second switch Z4, a second switch Z5, and a second switch Z6 shown in the figure) includes a first end, a second end, and a control end. The second ends of the three second switches of the second multiplexer M12 are all connected in parallel, and are coupled to the second polarity pin S21 through the second trace T21. The second ends of the three second switches of the second multiplexer M22 are all connected in parallel, and are coupled to the second polarity pin S22 through the second trace T22.

In addition, the control end of each of the first switch Z1 and the second switch Z4 is configured to receive a control signal from a first sub pixel R1. The control end of each of the first switch Z2 and the second switch Z5 is configured to receive a control signal from a second sub pixel G1. The control end of each of the first switch Z3 and the second switch Z6 is configured to receive a control signal from a third sub pixel B1.

In some embodiments, the first end of one of the at least three first switches is coupled to one of the second pixels through the first data lines. The first end of one of the at least three second switch is coupled to one of the first pixels through the second data lines. For example, please refer to FIG. 2, the control ends of the first switch Z2 and the second switch Z5 is configured to receive a control signal form the second sub pixel G1, the first end of the first switch Z2 is coupled to a first data line L1 so as to control the second pixel P21, the first end of the second switch Z5 is coupled to a second data line L2 so as to control the first pixel P11. In some embodiments, one of the first data lines and one of the second data lines forms at least one cross point in a vertical projection direction. For example, the first data line L1 and the second data line L2 are cross over to each other in the data line area A14. In addition, the first data line L1 and he second data line L2 are disposed on the different layers, and form at least one cross point in a vertical projection direction. It should be noted that the first data line L1 is configured to transmit pieces of first polarity data, and the second data line L2 is configured to transmit pieces of second polarity data.

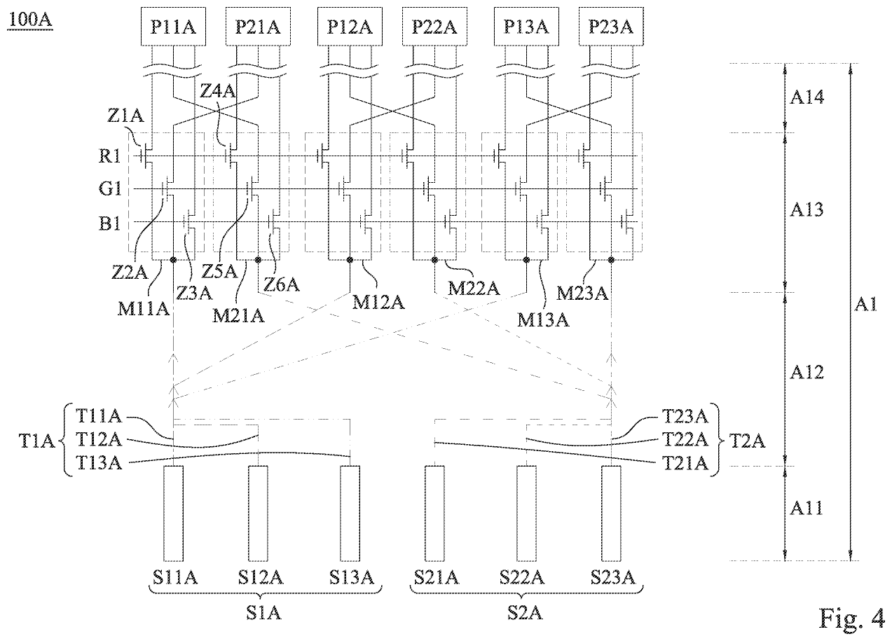

FIG. 4 depicts an enlarged view of a part structure diagram of a display device 100A according to some embodiments of the present disclosure. In some embodiments, compared to FIG. 2 with FIG. 4, embodiments in FIG. 4 change a first number of pair of first polarity pins S1A in the bonding area A1l and change a second number of pair of second polarity pins S2A in the bonding area A11.

In some embodiments, the pair of first polarity pins S1 A includes at least three first polarity pins and the pair of second polarity pins S2A includes at least three second polarity pins. The at least three first polarity pins are adjacent. The at least three second polarity pins are adjacent. The at least three first polarity pins and the at least three second polarity pins are arranged in an interlaced manner. The at least three first polarity pins are coupled to the first traces, and the at least three second polarity pins are coupled to the second traces. For example, please refer to FIG. 4, a first polarity pin S11A, a first polarity pin S12A, and a first polarity pin S13A are adjacent. A second polarity pin S21A, a second polarity pin S22A, and a second polarity pin S23A are adjacent. The three first polarity pins S1A and the three second polarity pins S2A are arranged in the interlaced manner.

In addition, the first polarity pins S11A are coupled to the first multiplexer M11A through the first traces T11A. The first polarity pins S12A are coupled to the first multiplexer M12A through the first trace T12A. The first polarity pins S13A are coupled to the first multiplexer M13A through the first trace T13A.

Similarly, the second polarity pins S21A are coupled to the second multiplexer M21A through the second trace T21A. The second polarity pins S22A are coupled to the second multiplexer M22A through the second trace T22A. The second polarity pins S23A are coupled to the second multiplexer M23A through the second trace T23A.

In some embodiments, the fan-out area A12 further includes a third conductive layer. The third conductive layer is disposed on the second conductive layer. Adjacent three first traces of the first traces are disposed on the first conductive layer, the second conductive layer, and the third conductive layer respectively, and are overlapped to each other in a vertical projection direction. Adjacent three second traces of the second traces are disposed on the first conductive layer, the second conductive layer, and the third conductive layer respectively, and are overlapped to each other in a vertical projection direction. For example, a first trace T11A, a first trace T12A, and a first trace T13A are adjacent, are disposed on the different layers, and are overlapped to each other in a vertical projection direction. A second trace T21A, a second trace T22A, and a second trace T23A are adjacent, are disposed on the different layers, and are overlapped to each other in a vertical projection direction.

In some embodiments, each of adjacent three first traces of the first traces is not coupled to each of adjacent three second traces of the second traces. For example, the first trace T11A and the second trace T21A are located on the first conductive layer. The first trace T12A and the second trace T22A are located on the second conductive layer. The first trace T13A and the second trace T23A are located on the third conductive layer. Each of the first traces T1A is not coupled to each of the second traces T2A.

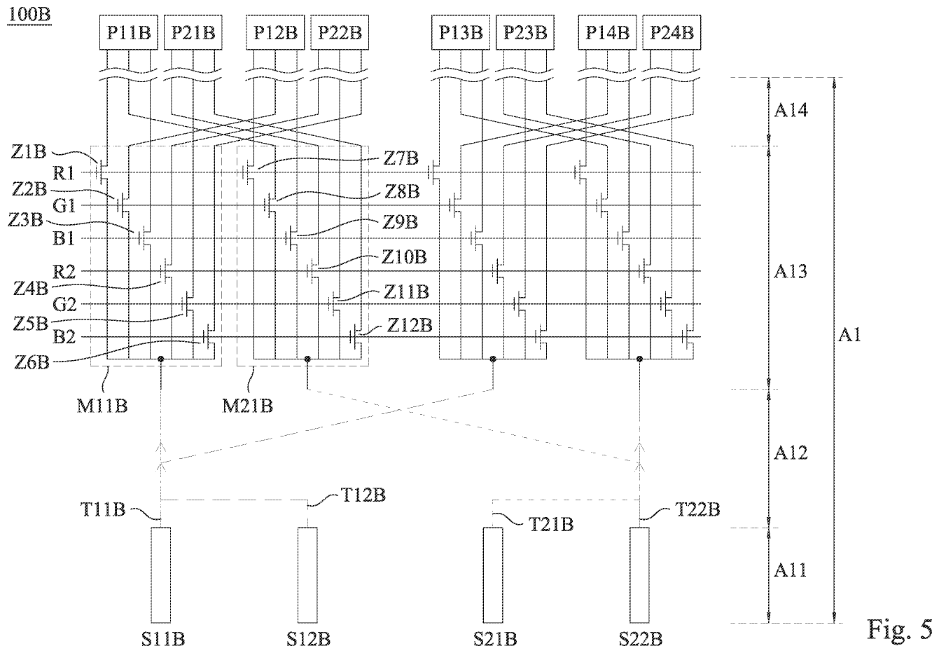

FIG. 5 depicts an enlarged view of a part structure diagram of a display device 100B according to some embodiments of the present disclosure. In some embodiments, compared to FIG. 2 with FIG. 5, embodiments in FIG. 5 change a third number of switches of the first multiplexers M11B in the multiplexer area A13, change a forth number of switches of the second multiplexers M21 B, and change the first pixels (ex. a first pixel P11B and a first pixel P12B) and the second pixels (ex. a second pixel P12B and a second pixel P22B) controlled by multiplexers. Two first pixels of the first pixels (ex. the first pixel P11 B and the first pixel P12B) and two second pixels of the second pixels (ex. the second pixel P12B and the second pixel P22B) are sequentially arranged as a first pixel P11 B in a first order, a second pixel P12B in a second order, a first pixel P12B in a third order, and a second pixel P22B in a fourth order.

In some embodiments, please refer to FIG. 5, the first multiplexer M11B includes six switches. The six switches from top to bottom are a switch Z1 B, a switch Z2B, a switch Z3B, a switch Z4B, a switch Z5B, and a switch Z6B. Each of the six switches includes a first end, a second end, and a control end. Please start from a top of components as a first end, each of the second end of the switch Z1B, the switch Z2B, the switch Z3B, the switch Z4B, the switch Z5B, and the switch Z6B is connected in parallel.

In addition, the second multiplexer M21 B includes six switches. The six switches from top to bottom are a switch Z7B, a switch Z8B, a switch Z9B, a switch Z10B, a switch Z11B, and a switch Z12B. Each of the six switches includes a first end, a second end, and a control end. Each of the second end of the switch Z7B, the switch Z8B, the switch Z9B, the switch Z10B, the switch Z11B, and the switch Z12B is connected in parallel.

In some embodiments, each of the control end of the switch Z1 B and the switch Z7B is configured to receive a control signal from a first sub pixel R1. Each of the control end of the switch Z2B and the switch Z8B is configured to receive a control signal from a second sub pixel G1. Each of the control end of the switch Z3B and the switch Z9B is configured to receive a control signal from a third sub pixel B1.

In addition, each of the control end of the switch Z4B and the switch Z10B is configured to receive a control signal from a first sub pixel R2. Each of the control end of the switch Z5B and the switch Z11B is configured to receive a control signal from a second sub pixel G2. Each of the control end of the switch Z6B and the switch Z12B is configured to receive a control signal from a third sub pixel B2.

In some embodiments, two of the six switches of the first multiplexer control the first pixel in the first order, one of the six switches of the first multiplexer controls the first pixel in the third order, one of the six switches of the first multiplexer controls the second pixel in the second order, two of the six switches of the first multiplexer control the second pixel in the fourth order. In some embodiments, one of the six switches of the second multiplexer controls the first pixel in the first order, two of the six switches of the second multiplexer control the first pixel in the third order, two of the six switches of the second multiplexer control the second pixel in the second order, one of the six switches of the second multiplexer controls the second pixel in the fourth order. For example, the switch Z1 B and the switch Z3B of the first multiplexer M11B control the first pixel P11 B in the first order. The switch Z5B controls the second pixel P21 B in the second order. However, the switch Z2B the first pixel P12B in the third order. The switch Z4B and the switch Z6B control the second pixel P22B in the fourth order.

In addition, the switch Z7B and the switch Z9B of the second multiplexer M21 B control the first pixel P12B in the third order. The switch Z11B controls the second pixel P22B in the fourth order. However, the switch Z8B controls the first pixel P11B in the first order. The switch Z10B and the switch Z12B control the second pixel P21 B in the second order.

In some embodiments, the peripheral area A1 shown in FIG. 1 includes the aforementioned embodiments shown in FIG. 2, or the aforementioned embodiments shown in FIG. 4, or the aforementioned embodiments shown in FIG. 5, or a combination of the aforementioned embodiments shown in FIG. 2, FIG. 4, and FIG. 5.

In some embodiments, compared to a consumption of the fan-out area of a prior art, a consumption of the fan-out area A12 can be reduced by about half due to a design of a two-polarity pins arrangement of the aforementioned embodiments in FIG. 2.

In some embodiments, compared to a consumption and a space height of the fan-out area of a prior art, a consumption of the fan-out area A12 can be reduced by about two-thirds due to a design of a three-polarity pins arrangement of the aforementioned embodiments in FIG. 2, and a space height of fan-out area A12 can be reduced. It should be note that if the fan-out area A12 is located on the XY plane, the space height is along Z direction.

In some embodiments, compared to a consumption of the fan-out area of three quarters due to a design of the multiplexers of the aforementioned embodiments in FIG. 5. In essence, the design is equivalent to changing the height of the fan-out area A12. It should be note that if the fan-out area A12 is located on the XY plane, the space height is along Z direction.

Based on the above embodiments, the present disclosure provides a display device so as to improve a consumption of a fan-out area of a display device. A design of a fan-out area of the present disclosure can reduce a space of a fan-out area for other circuit designs. The electric energy of a display device can be used effectively due to a design of a fan-out area of the present disclosure.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A display device, comprising:
a plurality of first pixels;
a plurality of second pixels, wherein the first pixels and the second pixels are arranged in an interlaced manner;
a plurality of first multiplexers, configured to control the first pixels, and comprising at least three first switches, wherein one of the at least three first switches is configured to control the second pixels;
a plurality of second multiplexers, configured to control the second pixels, and comprising at least three second switches, wherein one of the at least three second switches is configured to control the first pixels, wherein each of the first multiplexers and each of the second multiplexers are arranged in an interlaced manner;
a plurality of first traces, coupled to each of the first multiplexers;
a plurality of second traces, coupled to each of the second multiplexers; and
an integrated circuit, comprising:
at least two first polarity pins, wherein the at least two first polarity pins are adjacent; and
at least two second polarity pins, wherein the at least two second polarity pins are adjacent, wherein the at least two first polarity pins and the at least two second polarity pins are arranged in an interlaced manner, the at least two first polarity pins are coupled to the first traces, the at least two second polarity pins are coupled to the second traces, wherein a polarity of each of the first polarity pins is opposite to a polarity of each of the second polarity pins.

2. The display device of claim 1, wherein each of the first traces which are coupled to the at least two first polarity pins is adjacent, wherein each of the second traces which are coupled to the at least two second polarity pins is adjacent.

3. The display device of claim 2, wherein the display device comprises a fan-out area, wherein the fan-out area comprises a first conductive layer and a second conductive layer, wherein the second conductive layer is located on the first conductive layer;
wherein adjacent two first traces of the first traces are disposed on the first conductive layer and the second conductive layer respectively, and are overlapped to each other in a vertical projection direction;
wherein adjacent two second traces of the second traces are disposed on the first conductive layer and the second conductive layer respectively, and are overlapped to each other in a vertical projection direction.

4. The display device of claim 3, wherein each of the first traces is not coupled to each of the second traces, wherein the first traces and the second traces form at least one cross point in a vertical projection direction.

5. The display device of claim 4, wherein the integrated circuit further comprises:
at least three first polarity pins, wherein the at least three first polarity pins are adjacent; and
at least three second polarity pins, wherein the at least three second polarity pins are adjacent, wherein the at least three first polarity pins and the at least three second polarity pins are arranged in an interlaced manner, wherein each of the at least three first polarity pins is coupled the first traces, each of the at least three second polarity pins is coupled the second traces.

6. The display device of claim 5, wherein the fan-out area further comprises a third conductive layer, wherein the third conductive layer is located on the second conductive layer;
wherein adjacent three first traces of the first traces are disposed on the first conductive layer, the second conductive layer, and the third conductive layer respectively, wherein the adjacent three first traces are overlapped to each other in a vertical projection direction,
wherein adjacent three second traces of the second traces are disposed on the first conductive layer, the second conductive layer, and the third conductive layer respectively, wherein the adjacent three second traces are overlapped to each other in a vertical projection direction.

7. The display device of claim 6, wherein each of the adjacent three first traces of the first traces is not coupled to each of the adjacent three second traces of the second traces.

8. The display device of claim 1, wherein each of the at least three first switches comprises a first end, a second end, and a control end, wherein second ends of the at least three first switches are all connected in parallel, and are coupled to one of the at least two first polarity pins through one of the first traces;
wherein each of the at least three second switches comprises a first end, a second end, and a control end, wherein second ends of the at least three second switches are all connected in parallel, and are coupled to one of the at least two second polarity pins through one of the second traces.

9. The display device of claim 8, wherein the first end of one of the at least three first switches is coupled to the one of the second pixels through a first data line;
wherein the first end of one of the at least three second switches is coupled to the one of the first pixels through a second data line;
wherein the first data line and the second data line form at least one cross point in a vertical projection direction.

10. The display device of claim 1, wherein two first pixels of the first pixels and two second pixels of the second pixels are sequentially arranged as a first pixel in a first order, a second pixel in a second order, a first pixel in a third order, and a second pixel in a fourth order;
wherein each of the first multiplexers comprises six switches, wherein two of the six switches control the first pixel in the first order, wherein one of the six switches controls the first pixel in the third order, wherein one of the six switches controls the second pixel in the second order, wherein two of the six switches control the second pixel in the fourth order;
wherein each of the second multiplexers comprises six switches, wherein one of the six switches controls the first pixel in the first order, wherein two of the six switches control the first pixel in the third order, wherein two of the six switches control the second pixel in the second order, wherein one of the six switches controls the second pixel in the fourth order.
